(19) United States
(12) Patent Application Publication
(10) Pub. No.: US 2022/0141031 A1
(43) Pub. Date: May 5, 2022

(54) METHOD FOR GENERATING A DIGITAL PROOF OF THE TRANSMISSION OF A MESSAGE BY A UWB RADIO TAG, ASSOCIATED SYSTEM

(71) Applicant: UWINLOC, TOULOUSE (FR)

(72) Inventor: Luc ANTOLINOS, TOULOUSE (FR)

(21) Appl. No.: 17/260,445

(22) PCT Filed: Oct. 8, 2020
(86) PCT No.: PCT/EP2020/078269

§ 371 Date: Jan. 14, 2021

(30) Foreign Application Priority Data
Oct. 10, 2019 (FR) FR1911255

(51) Int. Cl. H04L 9/32; G01S 5/02; H04L 9/14

(52) U.S. Cl. CPC H04L 9/3247; H04L 9/3218; H04L 2209/80; H04L 9/14; H04L 2209/38; G01S 5/02529

(57) ABSTRACT

A method for generating a composite signature of a datum transmitted by a UWB radio tag, includes transmission of a message by a UWB radio tag; reception of the transmitted message by at least two reception beacons; generation of an enriched message including a temporal datum calculated from the arrival date of the first message and at least one signature by each of the beacons; and reception of the enriched messages by a calculator to determine a proof from the temporal data and signatures of each enriched message received.

The field of the invention relates to the field of methods aiming to secure and to ensure the integrity of a datum transmitted by a radio tag by means of a reliable third party. The field more particularly pertains to the generation of a composite signature of a datum transmitted by a radio tag. Finally, the field of the invention more specifically pertains to solutions for geolocation and securement of data transmitted by a radio tag in the UWB band.

Different solutions exist making it possible to ensure the integrity of a datum transmitted by a radio tag. Among existing solutions, enciphering methods may be employed. Solutions also exist targeting the exchange of keys between two systems making it possible to ensure that a datum received by a beacon is indeed the datum transmitted by a tag.

However, these solutions generally impose the establishment of a two-way link in order to enable functional interoperability between a receiver beacon and a transmitter tag.

When the link between the tag and the beacon is designed for the establishment of a one-way link, the integrity of the exchanged data may be obtained from the reception of the data by the generation of a fingerprint or a certification datum. However, nothing ensures that the datum is not usurped or modified after it has been received by a system having full knowledge of the data received.

The invention detailed hereafter makes it possible to offset the aforesaid drawbacks.

According to an aspect, the invention relates to a method for generating a digital proof relative to the transmission of a message by a UWB radio tag comprising:
Transmission of a message by a UWB radio tag;
Reception of said transmitted message by at least two reception beacons;
Generation of at least one enriched message each comprising a temporal datum calculated from the arrival date of the first message and at least one signature by each of the beacons;
Reception of the enriched messages by a calculator to generate a digital proof from the temporal data and the signatures of each enriched message received.

An advantage is to generate a composite signature from a plurality of signatures realized by each beacon. An interest is to certify the presence of a tag in a given zone by different beacons and being able not to be in direct link.

According to an embodiment, at least one beacon is not connected to another beacon of the set of beacons having received the message transmitted by the UWB radio tag. An advantage is to generate a composite proof from distributed proofs, such as signatures, from a system not communicating together.

According to an embodiment, each beacon comprises a memory in which is stored a digital key making it possible to generate a signature, at least two beacons comprising different keys. An interest is that each beacon has its own signature system which can be different from one beacon to the other. Thus, the system making it possible to certify the presence of a tag may be shared by several operators each having their own beacon.

According to an embodiment, each beacon generates a signature different from the other beacons.

According to an embodiment, the method comprises a step of reception of enriched messages by a calculator to determine a position of said UWB radio tag from the temporal data of each enriched message generated by each beacon. The position may be calculated by one of the beacons, a remote server according to the configuration of the chosen system.

According to an embodiment, the signature data and the temporal data of each enriched message are stored in a data container forming a block of a blockchain, each block of said blockchain comprising a specific digital fingerprint. An interest is to aggregate in a same chain blocks linked to events seen by the beacons within a same zone. An advantage is to facilitate the exploitation of the data collected.

According to an embodiment, the set of enriched messages generated by a beacon over a predefined time period are stored in a same blockchain.

According to an embodiment, the set of enriched messages generated by the set of beacons covering a same geographic zone over a predefined time period are stored in a same blockchain.

According to an embodiment, the digital proof comprises:
At least one pair of digital values, each digital value comprising at least one digital signature or;
The result of an operation aiming to correlate the values of the different signatures.

According to an embodiment, a calculator carries out an operation aiming to verify the conformity of the digital proof, said operation associating the different temporal data and the signatures of each beacon for each message transmitted by a radio tag.

According to an embodiment, a calculator of each beacon generates a log to at least one data server for storing the different temporal data and the signatures associated with the set of messages received from each beacon, said stored data being made accessible to a third party after an access control of said third party with a rights management service.

According to an embodiment, a device for transmitting a clock disseminates a synchronization datum to the different beacons.

According to an embodiment, the method comprises a step of generation of a composite signature from the set of signatures generated by each beacon during the reception of a same message transmitted by the UWB radio tag.

According to an embodiment, the UWB radio tag is associated with an electronic equipment comprising at least one sensor, said sensor measuring a datum of a physical parameter, said datum being inserted into the message transmitted by the UWB radio tag, said datum being associated with the signature of each beacon for the calculation of a proof.

According to an embodiment, each beacon is configured to receive a datum from an electronic equipment comprising at least one sensor, said sensor measuring a datum, said datum being inserted into a new message transmitted by the electronic equipment, said datum being associated with the signature of each beacon for the calculation of a proof.

According to an embodiment, each beacon is configured to receive a datum from an electronic equipment comprising at least one sensor, said sensor measuring a datum, said datum being inserted into a new message transmitted by said beacon, said datum being associated with the signature of each beacon for the calculation of a proof.

According to an embodiment, each beacon receives a same data stream transmitted by a data source, the method comprising a step of extraction of a portion of data from said data stream carried out by each beacon having received at least one message coming from a tag, said extracted data portion being integrated in an enriched message consecutively to the reception of a message received by a tag ET₁.

According to another aspect, the invention relates to a system comprising a set of beacons comprising a receiver for receiving messages transmitted by a UWB radio tag, each beacon comprising a demodulator to extract the data received from said message, a calculator to:
extract at least one identification datum from said radio tag;
calculate a temporal information time stamping the reception of a message transmitted by the tag, said temporal marker being generated from a clock and a synchronization message, each beacon comprising an interface for receiving said synchronization signal and a memory for storing at least one digital key of said beacon,
generate a digital signature of a set of data, said data being signed from at least said identification datum, the temporal information and a digital key stored in a memory of said beacon;

each of said beacons further comprising a transmitter for transmitting an enriched message comprising at least the identification of the tag, a temporal information generated by each beacon and a digital signature generated by each beacon, said system further comprising a data server configured to generate a proof from the different enriched messages received.

Other characteristics and advantages of the invention will become clear on reading the detailed description that follows, with reference to the appended figures, which illustrate:

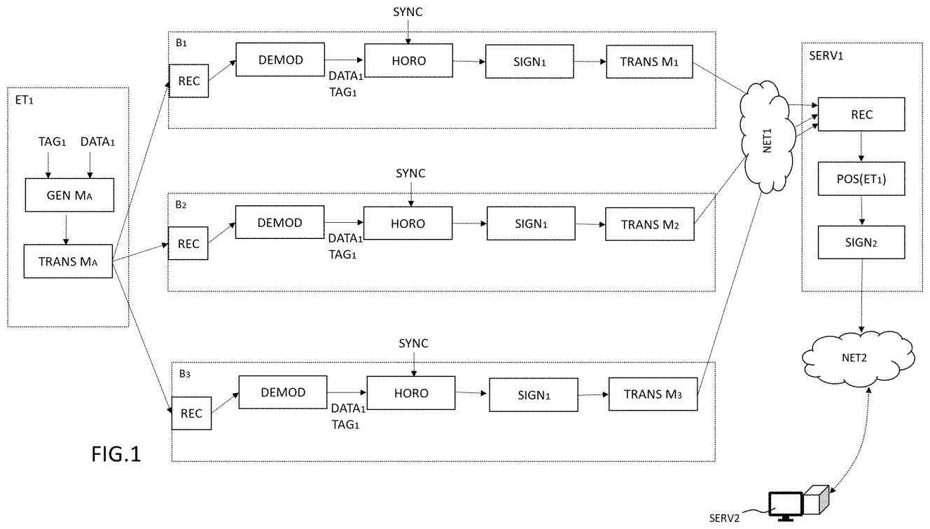

FIG. 1: the different steps of an embodiment of the method of the invention implemented by a system comprising three beacons;

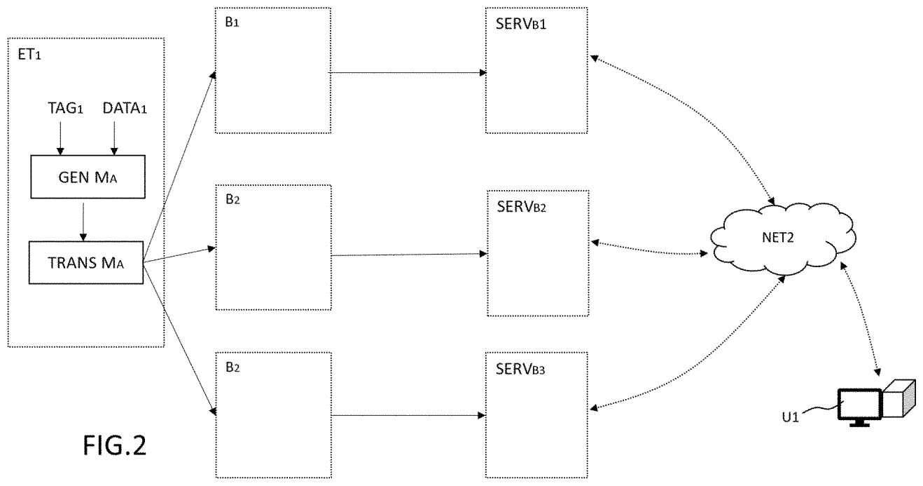

FIG. 2: an alternative embodiment of the method of the invention in which the steps of processing by each beacon comprise a transmission of the enriched messages to respectively a dedicated server;

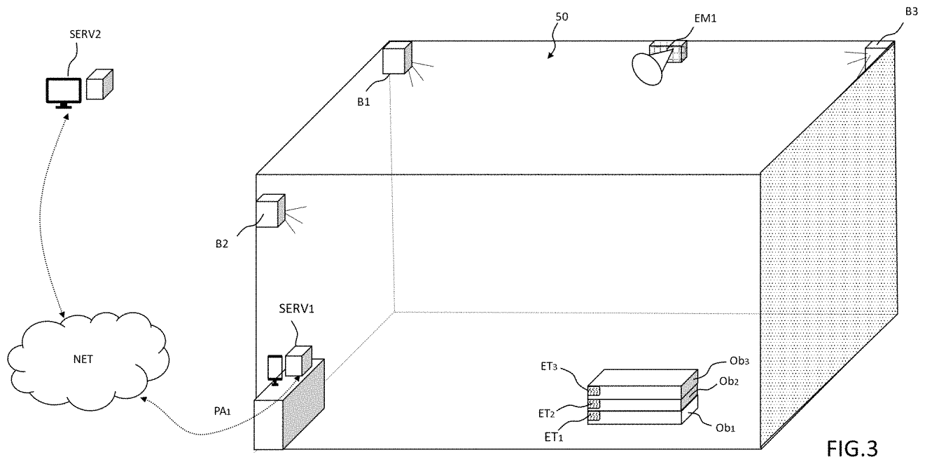

FIG. 3: an exemplary embodiment of a system of the invention arranged within an enclosure in which objects comprising a UWB radio tag are stored;

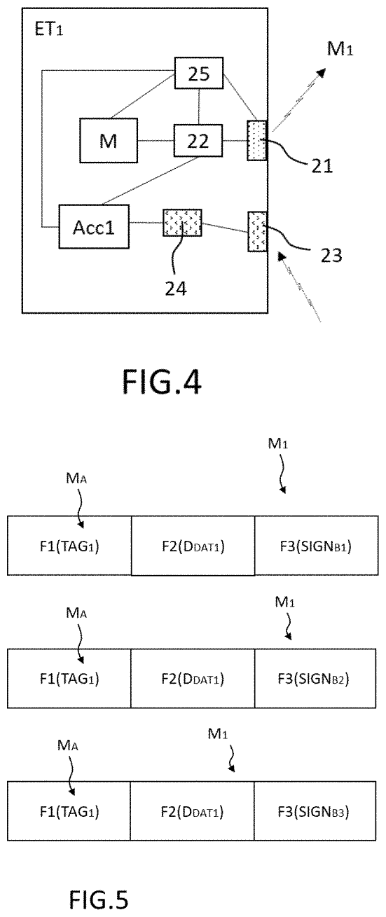

FIG. 4: an example of UWB radio tag of a system of the invention,

FIG. 5: an example of data fields generated by a software of the invention comprising different signatures produced by the different beacons of the system of the invention.

A composite signature designates a signature established by at least two different signatures. The composite signature may thus be a pair of values, for example signatures generated by different beacons. The composite signature may comprise a plurality of signatures, in general three signatures, which makes it possible to geolocate a UWB radio tag having transmitted a message received by at least three beacons.

The composite signature may be obtained by extracting field signatures from different messages or data frames. According to another example, the composite signature may be obtained by extracting signatures from different blocks of a blockchain.

According to an example, the composite signature may be generated from a calculation of data representing different signatures generated from several beacons.

FIG. 1 represents the different steps of an embodiment of the method of the invention. The steps are represented in the respective items of equipment implementing each of the steps.

A UWB radio tag ET₁ comprises a calculator making it possible to generate a message M_{A}, step noted GEN_M_{A}. The message M_{A} comprises, for example, an identifier of the tag TAG₁. It may also comprise a datum specific to the tag or a datum specific to the collection of a datum by another system. As an example, a datum DATA₁ may be encoded in the message M_{A}. The datum DATA₁ comes, for example, from another system, such as a device comprising a sensor generating a datum DATA₁ originating from a measurement. In the simplest embodiment thereof, the message M_{A} only comprises an identifier TAG₁ making it possible to recognize or identify the tag ET₁.

The UWB radio tag ET1 comprises a transmission module making it possible to transmit a message M_{A}, this step is noted TRANS_M_{A}. The transmission comprises the shaping of the transmitted signal, the modulation and the transmission from a transmitter antenna of the message in the UWB range of frequencies. FIG. 4 represents in greater detail an exemplary embodiment of a UWB radio tag.

A plurality of beacons B₁, B₂, B₃ are arranged in a geographic zone. The invention finds an interest from the moment that two beacons are present to receive the message M_{A} transmitted by the UWB radio tag. However, this configuration does not make it possible to obtain a position {x, y} of the tag in space with a constant altitude, i.e. with given z, but uniquely to certify that it has been detected in a zone at a given date. Indeed, with three beacons, it is possible to obtain the pair {x, y} of coordinates in a room for example, that is to say with z constant, that is to say at a given altitude. It is necessary to have 4 beacons to obtain a position in space according to three dimensions {x, y, z}. In this latter example, {x, y, z} designates the coordinates in a local cartesian reference system. Any other type of reference system may be used such as a polar reference system, a cylindrical reference system or a spherical reference system. According to an example, the latitude, the longitude and the altitude may thus be used.

The invention finds a particular interest when at least three beacons are arranged in a given geographic zone to receive the messages M_{A} transmitted by a UWB radio tag in this zone. Indeed, this configuration makes it possible not only to certify the passage of a tag ET₁ in this zone, but also to determine the position {x, y} of said tag ET₁. The zone is defined such that a set of beacons lies within sufficient range to receive this message M_{A}.

Each beacon B₁, B₂, B₃ comprises a reception antenna in order to receive the message M_{A} transmitted by the tag ET₁. The reception step is noted REC within each beacon B₁, B₂, B₃ represented in FIG. 1. The signal is next demodulated from a demodulator such as a radiofrequency component, the step is noted DEMOD in FIG. 1.

The demodulation DEMOD makes it possible to extract the useful data from the message M_{A} of which the identifier TAG₁ and possibly useful data DATA₁ when such data are transmitted by the radio tag ET₁.

Each beacon B₁, B₂, B₃ receives a synchronization signal coming from another system. The synchronization signal is, for example, a signal comprising a temporal marker distributed to each beacon, said signal being generated from a remote clock. The synchronization datum is, for example, received by each beacon in the form of a data TAG coming from a third party system. The synchronization signal is noted SYNC in FIG. 1.

In an embodiment, the synchronization signal is transmitted from a synchronization tag. The latter may comprise supply means for ensuring the transmission of said synchronization signal continually or periodically. The synchronization tag is preferentially arranged at a fixed position known to the beacons or a server exploiting the data of the messages received by the beacons which have been time stamped on their reception.

In an embodiment, the synchronization tag transmits a signal comprising its own position which will thus next be exploited either by the beacons or by a server exploiting this information. The position of the synchronization tag may be optionally signed. A signature notably makes it possible to ensure that a third party does not try to synchronize the system with counterfeit signals.

Optionally, the synchronization tag may generate in the transmitted message a local time which is associated with the position data for example. In this latter embodiment, the synchronization tag thus integrates in the message that it transmits its identifier, its position and a local date.

The method of the invention further comprises a step of signature SIGN₁ of the data originating from the message M_{A}. According to different alternative embodiments, the signature of the data also comprises other data than the data extracted from the message M_{A}. The signed data may for example comprise an identifier of the beacon, a temporal datum such as the date of reception of the message M_{A}, a datum coming from a sensor associated with the beacon, etc. The signature step ends up in the generation of a signature, noted SIGN_{B1}, SIGN_{B2}, SIGN_{B3} according to the beacon B₁, B₂, B₃ which processes the data received and transmitted by the radio tag ET₁.

The method of the invention then comprises a step of generation of an enriched message M₁, M₂, M₃ comprising at least the identifier TAG₁ of the tag ET₁ and a signature SIGN₁, SIGN₂, SIGN₃. The signature is realized at the step SIGN₁ in each beacon.

When useful data DATA₁ are received, the signature step SIGN₁ is applied to all or part of the data of the message M_{A}. If the message M_{A} comprises useful data DATA₁ additional to the identifier TAG₁, a signature may be generated from the identifier data TAG₁ or instead the set of identifier data TAG₁ and the useful data DATA₁. Once the signature generated, a calculator of each beacon makes it possible to generate an enriched message M₁, M₂, M₃ comprising the data of the message M₁, the signature and a temporal information D_{DAT1}.

Each enriched message M₁, M₂, M₃ advantageously comprises a temporal datum D_{DAT1} corresponding to a time stamping carried out by the beacon from a clock synchronized with the other beacons. Synchronization is made possible thanks to the reception of a synchronization datum SYNC. In the remainder of the description, the messages M₁, M₂ and M₃ in the exemplary case of three beacons B₁, B₂, B₃ may be described from the example of a message for example M₁. The same processings applied to transmit a message M₁ to a server apply to other beacons to transmit respectively enriched messages M₂, M₃.

In an embodiment, the synchronization of the clocks of the beacons is carried out thanks to the reception of a synchronization signal transmitted by a transmitter such as a synchronization tag of which the position is known by the beacons or the server exploiting the time stamped messages.

The synchronization tag may, for example, send a synchro top at regular intervals to the beacons with its position. The synchro top may comprise a datum comprising a transmission date. This datum may be signed optionally.

In another embodiment, the synchro tops are received by the beacons. This synchronization information is then sent directly to a server at the same time as the messages M₁, M₂, M₃. It is next the remote server that calculates the position(s) from the synchro tops and the messages received.

Signature, Key, Certificate

According to an embodiment, each beacon comprises data in a memory making it possible to generate a signature SIGN₁. The signature may be calculated from the data of a root certificate comprising, for example, an identifier, a name, a public key. The generated signature may thus lead to generating a signed certificate.

According to an embodiment, each beacon comprises specific data making it possible to generate its own signature. An interest is to make different systems, not communicating with each other and capable of comprising items of equipment different from one beacon to the other, cooperate. The beacons may come from different manufacturers having their own system for certification and transmission of a signature.

According to an embodiment, the beacons are not physically connected to one another. According to an example, they are not connected by a wireless link or a physical link. The beacons are advantageously blind to each other. They have the capacity to receive the same messages M_{A} transmitted by a radio tag ET₁ and the same synchronization data SYNC from a reference clock. However, the beacons do not see each other from a point of view of data exchanged between them. An interest is to guarantee an integrity of the signatures generated by each beacon. An advantage is to define a distributed system ensuring the function of reliable third party while having available a set of data capable of certifying the presence of a radio tag ET₁ in a given zone at a given date.

According to an embodiment, the enriched messages M₁, M₂, M₃ may then be transmitted to a remote server SERV₁. According to an embodiment, each beacon sends the processed enriched message to a remote server associated with the beacon B₁, B₂, B₃. According to another example, all the beacons send their respective enriched message to a central server SERV₁. According to another case, the two embodiments are combined. In this latter case, each beacon transmits the processed enriched message to a remote dedicated server and to a centralized server collecting all the enriched messages of each beacon.

FIG. 1 represents the steps of processing the enriched messages M₁, M₂, M₃ received by a server SERV₁ centralizing the different receptions of each beacon B₁, B₂, B₃. According to an example, a step of reception of each message, noted REC, may be carried out from a data communication interface. The server SERV₁ may be connected to a data network NET₁ through which the beacons B₁, B₂, B₃ transmit the enriched messages M₁. According to a configuration, the server SERV₁ is configured to process the temporal data D_{DAT1} of each message M₁ in order to calculate the position of the tag while considering the times-of-flight Δtvol or arrival time measurements. It is recalled that the temporal data may be for example an information of date of reception of a message coming from a tag ET₁, the date of reception being generated by a clock synchronized with the other beacons.

According to other alternative embodiments, the temporal information D_{DAT1} transmitted to the server SERV₁, may be obtained at the level of said reception beacons from:
the arrival times of the UWB messages in order to deduce therefrom the time-of-flight differences of the latter and/or;
the arrival powers of the UWB messages and/or;
the arrival frequencies of the UWB messages.

From each temporal information D_{DAT1} collected, according to an embodiment, the method of the invention comprises a step for calculating the position of the tag ET₁. This step is noted POS(ET₁) in FIG. 1. The measurement of the position of the tag ET₁ may be obtained thanks to the implementation of a trilateration algorithm. This step corresponds to an embodiment, but according to another embodiment described in FIG. 2, the position of the tag may not be exploited directly to provide a proof of the presence of a ET₁ at a given spot. Indeed, the simple event corresponding to the reception of a message transmitted by the tag ET₁ and received by a beacon ensures proof that the tag has been “seen” by this beacon. When the message is received by a plurality of beacons, an interest of the invention is to provide a proof of passage of the tag ET₁ in a reception zone of said beacons, without necessarily calculating a position of the tag.

The invention finds an interest in this embodiment which ensures an entity obtains a plurality of proofs coming from different beacons not communicating with each other. This configuration makes it possible to generate an unfalsifiable proof of the passage of the tag in a given zone, for example when it is associated with a moving object.

In order to generate a proof of detection of a tag ET1, the calculation of the position, when it is carried out, may not converge precisely. Indeed, the signals received by the beacons may be altered by radio noise, synchronization tops too distant, or other interference, multi-path phenomena, false positives or any other parasitic effects linked to radio transmissions. However, when the position of the tag ET₁ is calculated, the method and the system of the invention making it possible to obtain a calculated position which may have a radius of uncertainty and/or an index of probability of being in a zone. For example, a probability index associated with the calculated position may be implemented. This latter algorithm may be of the type of those used to evaluate the quality of a GPS position such as algorithms for calculating circular error probable CEP₅₀ or CEP₈₀. According to another example, an algorithm calculating a sliding average such as a root mean square error RMSE, for example, over the X final positions, and thus the X messages received from the N beacons, may be implemented to confirm, for example, a persistence of several detections in a same zone.

In the case of FIG. 1, and according to an embodiment, the different messages M₁ are transmitted to a server which can calculate the position of the tag ET₁ and generate a proof while verifying the integrity of the messages received by the different beacons. If the different temporal information D_{DAT1} associated with a same tag identifier ET₁ are coherent, a proof may be obtained. In this latter case, according to an embodiment, the server SERV₁ may, for example, generate a composite signature SIGN₂ corresponding, for example, to the position of the tag ET₁ signed from the temporal information D_{DAT1} received from each signature SIGN_{B1} SIGN_{B2} SIGN_{B3} of each beacon. An interest is to deliver a signature with an information constructed from the different signatures or more generally from data of different beacons. The position is, for its part, calculated from the temporal information D_{DAT1} of each beacon.

According to an embodiment, the server SERV₁ is then able to transmit a datum to a remote server SERV₂ by a data link through a data network NET₂. The data network is, for example, the same as the network NET₁ or it may also be a different network. According to an example, the network NET₁ is a private data network and the data network NET₂ is a public network. According to an example, the server SERV₂ is an application server which collects the position of a tag ET₁ and a proof such as the signature SIGN₂ which makes it possible to find each signature SIGN_{B1}, SIGN_{B2}, SIGN_{B3} from a digital key. According to an example, each beacon B₁, B₂, B₃ has encoded beforehand a datum specific to said beacon in their respective signature SIGN_{B1}, SIGN_{B2}, SIGN_{B3} which may be recovered by the application server SERV₂.

FIG. 2 represents an alternative embodiment in which each message M₁ received by each beacon B₁, B₂, B₃ corresponding to a same transmission of a radio tag ET₁ is retransmitted to a server dedicated respectively to each beacon B₁, B₂, B₃. The dedicated servers are noted SERV_{B1}, SERV_{B2}, SERV_{B3}. These latter servers are for example application servers accessible from a public network NET₂ by at least one user U₁. In this scenario, the user U₁ can recover, via the data link and an access control, a datum proving that the tag ET₁ has been detected by two independent systems. According to an embodiment, it also recovers the temporal information D_{DAT1} enabling it to calculate the position of the tag ET₁. An interest of this solution is to deliver an access to a user U1 of a service, for example a WEB service, enabling it to collect the proofs with the different players having ensured the detection of the presence of a tag ET1 in a given zone.

Thus, the method of the invention makes it possible to offer a particularly reliable solution to a user ensuring it of a certain proof formed of set of proofs of a detection of a tag ET₁. The different beacons form different authorities defining independent reliable third parties being able to deliver proofs to a user.

FIG. 3 represents an enclosure 50 which may be a room, a hangar, a building forming a perimeter in which beacons are installed. The beacons B₁, B₂ and B₃ are arranged at different positions of the enclosure. Their arrangement is preferentially optimized to cover a maximum zone. The enclosure is in this exemplary case a completely enclosed enclosure. In alternative embodiments, the zone to cover may also be an exterior zone, such as a tarmac, a car park or instead a quay. However, the invention is not limited to these examples. Any zone being able to be covered by a plurality of beacons is capable of being a detection zone in which the method of the invention may apply.

FIG. 3 represents a set of objects Ob₁, Ob₂, Ob₃, each object being provided with a tag ET₁, ET₂ ET₃. Each tag is affixed to an object. In the scenario of the invention, the tags ET₁, ET₂ and ET₃ are UWB tags collecting an energy by radio waves transmitted by a transmitter, represented in FIG. 3, by the transmitter EM₁.

According to an exemplary embodiment, each tag comprises a radio reception for receiving a stream of radio waves. In this embodiment, a transmitter beacon such as the transmitter EM₁ transmits a radio stream destined for each tag to collect a radio frequency energy.

According to an embodiment, a transmitter beacon of a radio stream may be one or more wireless electrical supply units spread out over the geographic zone covered by the beacons B₁, B₂ and B₃. In this embodiment, the wireless electrical supply units remotely supply the tags with electrical energy.

The transmitter beacons, also designated “wireless electrical supply units”, are distinct from the receiver beacons B₁, B₂, B₃. Nothing excludes however, according to other examples, having one or more of said wireless electrical supply units which are integrated in one or more receiver beacons B₁, B₂, B₃, such that at least one equipment of said system is both a wireless electrical supply unit and a receiver beacon.

In this exemplary case, each beacon B₁, B₂, B₃ can receive a message transmitted by the tag ET₁, ET₂ and ET₃ and sign the reception of the message. According to this arrangement, as long as the tags are in the zone covered by the beacons, they can transmit signals. The beacons may thus constitute proofs continuously over a time interval proving the presence of the tags over a lapse of time. As long as the tags transmit, the beacons can generate a signature.

In the case of FIG. 1, a server SERV₁ receives the enriched messages M₁ from each beacon. The server is here accessible from a remote server SERV₂ according to the exemplary case of FIG. 1.

Embodiment of a Radio Tag

FIG. 4 represents an exemplary embodiment of a radio tag ET₁ of UWB type. The tag ET₁ comprises a receiver 23 collecting radio waves transmitted by a transmitter EM₁ (not represented in FIG. 4). The tag ET₁ further comprises a rectifier 24 making it possible to charge an accumulator Acc₁ with electrical energy. The rectifier 24 can convert the spectral power received by the radio reception module 23 into an electrical voltage or current. The converted energy may then be stored in an electrical accumulator Acc₁. The electrical accumulator Acc₁ thus behaves like a battery making it possible to deliver the energy required for the transmission of UWB messages.

The accumulator Acc₁ is configured to supply a set of electronic components such as the control module 22, the block transmitter comprising a modulator 25 and an antenna 21. A memory M is here represented. The memory M may comprise, for example, the identifier of the tag ET₁ which is transmitted with the message M_{A}.

FIG. 5 represents an example of a message M₁ comprising a field F₁ comprising the identifier received from the tag ET₁, here noted TAG₁. This identifier has been extracted from a message M_{A} transmitted in a UWB frame.

A second field F₂ comprises a datum relative to a temporal information D_{DAT1}. The temporal information D_{DAT1} corresponds to the arrival date of the message M_{A} which is calculated from a clock synchronized between each beacon B₁, B₂, B₃. It is thus a priori different in each beacon according to the distance at which is found the tag ET₁ of the beacons B₁, B₂, B₃. In the particular case where a tag ET₁ is at equidistance from two beacons, the arrival date of the message received in each of said two beacons will be substantially identical. A third field F₃ comprises a signature SIGN_{B1}, SIGN_{B2}, SIGN_{B3}. This signature may be generated from a datum specific to each beacon B₁, B₂, B₃.

According to another embodiment, the signature of the data received by each beacon is realized by a plurality of remote servers, each remote server being connected to a given beacon and signing the raw data of a message received by a beacon. In this embodiment, a central server recovers each temporal information in order to calculate a position or a zone in which is found the tag ET₁. An identifier may also be associated with this position or this zone. According to an exemplary case, the position of the tag ET₁ may be exploited by a client application, such as a computer program, executed by a mobile terminal, a computer or a server connected to a service exploiting the position. According to an embodiment, the central server, when it receives a new position of a tag, can transmit a notification to the client application which is subscribed to a service with the central server.

In this case, the content of each message received by a beacon is stored by a server independent of the other servers. It may be transmitted to the client application.

An interest of this solution is that the client application comprises means for transmitting requests with each independent server associated with each of the beacons. The composite signature is thus realized by the client application. In this case the composite signature is a verification of the coherency of the raw data vis-à-vis the calculated position. An interest of this solution is to avoid sending signed data when possibly the keys may be compromised in the signature of the raw data processed by the tag ET₁ or by the beacon. The composite signature may also be realized by a second independent server when the data received by the client application are re-exploited by a first independent server. Alternatively, it may be a server that is not one of the independent servers associated with a beacon. Here again, the generation of a composite signature may comprise the simple verification of the coherency of the raw data with each other. The coherency may comprise a verification of the presence of an expected useful datum in the message of each beacon or instead a comparison of the arrival times of the messages with each other, for example that they are all comprised in a given lapse of time of which the duration is below a given threshold.

According to an exemplary embodiment, each beacon is connected through a data network or a data link to a data source transmitting a data stream. The data stream may be a pseudo-random stream. According to an embodiment, each beacon receives the same data stream. According to an example, no datum is transmitted by the beacon on this link. It may be a data stream disseminated on the internet.

According to an embodiment, each time that a beacon receives a message M_{A} transmitted by a tag ET₁, said beacon automatically extracts a portion of the data received from the data stream and integrates it in the enriched message M₁ produced by a beacon. It may be a predefined number of octets of the data stream received. The portion extracted from the data stream may be extracted on reception of the message M_{A} or instead at given times as a function of a clock common to all the beacons. According to an embodiment, in addition to the portion of the extracted data stream, a date information is associated with the extracted portion in order to improve the operation of comparison of these sequences integrated by different beacons. It may advantageously be the date at which the extraction has taken place.

An advantage is to add a datum making it possible to carry out a verifiable correlation operation. Indeed, each message received by each beacon comprises an extract of the common data stream exploited by each beacon. It is thus possible to verify that the enriched messages come from a same transmission of a tag. This solution offers a complementary digital proof of the date of reception. If a third party wishes to generate a falsified “proof” of reception of a UWB message, it would be necessary for said third party to know the exact date of reception of the UWB message and to exhibit the octets of the random stream associated with this particular moment. This solution thus makes it possible to increase the integrity of the data received by each beacon during their exploitation by client applications.

Association with an Electronic Equipment

According to an exemplary embodiment, a tag ET₁ is associated with a mobile electronic equipment, such as a smartphone. According to other examples, other devices may be associated with a mobile electronic terminal. According to an example, the tag ET₁ forms a set of components integrated in a mobile terminal. In this exemplary case, said mobile terminal may be considered as a UWB transmitter.

An interest is to make it possible to transmit a proof of a passage of an equipment in a given zone.

Association with a Sensor

According to an exemplary embodiment, the radio tag is associated with an equipment comprising a sensor of a physical quantity, such as the temperature, the humidity, a pressure, a datum characterizing the physical datum, an image or instead a modification of said datum characterizing the image. The tag ET₁ electronically coupled with such an equipment by a physical link or a wireless link is configured to save this time stamped physical parameter and to store it in a memory, such as the memory M. In this embodiment, the message M_{A} transmitted to the beacons B₁, B₂, B₃ comprises a value of the physical parameter exchanged and time stamped between the tag and the sensor. An interest of this solution is to consolidate a proof of the detection of the tag in a given zone when the tag may be coupled with a sensor.

According to another embodiment, each beacon B₁, B₂, B₃ is coupled with a sensor. The sensor is for example a sensor measuring a physical quantity such as the temperature, the humidity, a pressure, a datum characterizing an image or instead a modification of said datum characterizing the physical quantity. Each beacon is then configured to store the physical quantity and to associate it with a temporal datum to time stamp it. The physical quantity measured by the sensor is associated temporally with the reception of the message M₁ to calculate subsequently the position of the tag ET₁. An interest of this solution is to consolidate a proof of the detection of the tag in a given zone when the beacon is coupled with a sensor. Indeed, each value of the physical parameter should in principle be coherent with those stored by the other beacons. This datum may be taken into account in the generation of the signature of each beacon SIGN_{B1}, SIGN_{B2}, SIGN_{B3}.

When the tag ET₁ and each beacon B₁, B₂, B₃ are associated with a datum measured by a sensor, a control of the coherency of the measured data is, for example, carried out within each beacon. Such a control may also be parameterized within a remote server. As an example, if the measured physical parameters are images, the images acquired by each optic associated with each beacon may be compared subsequently to verify the coherency of the proofs with each other.

Blockchain

According to an embodiment, the data of the enriched messages M₁ are transmitted within a server which is configured to generate a block of a blockchain. An interest is to aggregate in a same chain blocks comprising received data coming from each beacon. Thus, a chain may be created to aggregate all the events of a zone seen by a plurality of beacons.

According to another embodiment, the chains are organized according to a tag identifier. Thus, each chain comprises a data block transmitted by a beacon tracing the activity of a tag.

Different embodiments may be implemented in order to generate a blockchain of which the data are aggregated as a function of a given configuration: surveillance of a place, surveillance of a tag, etc.

According to this embodiment, the blockchain is then transmitted to an application server or a terminal or instead a data server for the exploitation of the collected data.

An application finds an interest in the securement of a transaction such as a payment in order to ensure that a transaction has indeed taken place in a given zone.

This solution has the advantage of doing away with the use of a central server such as a remote server controlling for example an identification of a user. In this case, the implementation of a blockchain makes it possible to obtain copies of data of the transaction that are considered reliable. In this example, the central server may be replaced by a blockchain comprising different nodes corresponding to the transactions.

Another application of the invention may be implemented by arranging the beacons in a zone of an airport to control that trolleys, luggage or items of equipment are identified at certain places. The invention notably finds a remarkable interest when different players each having their own beacon, receiving a same synchronization signal, have configured their beacon to receive a message transmitted by a radio tag in the UWB band. Each player may then provide a proof of a detection. All of the proofs then form a composite proof authenticating the event.

Another example relates to the case of the management of access to at least one car in a car park having such a system of beacons. The car may, for example, comprise a beacon. It is assumed that the car is able to know its position in the car park, whatever the envisaged positioning system. A possibility is that it obtains its position in UWB with a system of beacons distributed in the car park. When a remote key is used to open the car, the key being associated with a UWB tag, the position of the key may be calculated by the location system comprising the beacons. The method of the invention then makes it possible to verify that it is close to the car. The beacons may be arranged at different places of the car park and potentially within a car.

The method of the invention makes it possible to generate a proof thus distributed between the different vehicles thus making more complicated a remote opening by a pirate transmitter situated outside of the car park. Such a system proposes a solution making it possible to be free of car theft through the use of an amplifier.

According to an embodiment, a street equipped with beacons on its street lamps and a beacon in the car or in the house makes it possible to define a location system making it possible to locate a key remotely. The method triangulates the key only when it is situated near to the car and not when it is situated beyond a given distance threshold. Thus, an amplification system of a key present at a certain distance cannot activate the opening of the car.

Pull-Out Detector

In an embodiment, the beacon comprises at least one pull-out and/or position detector. An exemplary embodiment may be realized thanks to a sensor for measuring wall distance. Any other type of sensor making it possible to evaluate a change of position of the beacon may be used alternatively or conjointly. For example, a GPS signal or a WiFi terminal may also be used to evaluate a change of position of the beacon. According to another possibility, a movement sensor may be associated with the beacon to generate an indicator of displacement of the latter. The movement sensor may be of gyroscopic or acceleration type such that an orientation and/or a displacement of the beacon are detectable. Alternatively, a sensor of “feeler” type such as a contact feeler may be used. Such a feeler may be configured to trigger for example a switch when contact is not maintained.

In this embodiment, in the event of detection of displacement of a beacon, the method of the invention comprises a step aiming to stop the exploitation of the positions of said beacon. The beacon is then no longer considered as valid. A message may then automatically be transmitted to a server to declare an incapacity of the beacon to validate a measurement. An advantage is to protect against a possible attack which could consist in displacing jointly the three beacons in another place while retaining the geometry that they had between them. Such an attack could make it possible to entail that a compliant detection of a tag in this new place by the displaced beacons has been displaced in another place.

According to an embodiment, a device transmitting a synchro top to the beacons ensures that the messages received by said beacons may be time stamped relatively to each other in a reliable manner.

Such a device transmitting a synchro top, also called synchronization signal, may comprise an anti pull-out system such as described previously for the beacons. The device transmitting a synchro top may be, for example, an active tag of which the position is known or a reference beacon comprising a module having a reference clock and capable of generating synchro tops from this clock. The synchro top is for example a synchronization frame which is transmitted at predefined periods. The pull-out detector thus makes it possible to certify the signal transmitted by the device transmitting the synchro top.

When the device transmitting the synchro top is pulled out, then the method of the invention makes it possible to invalidate the device transmitting the synchro top automatically. A step aiming to warn of such a pull-out may be implemented. According to an example, the device no longer transmits the synchro top when a pull-out is detected. The interest of such a solution is to be protected against an attack that attempts to displace this synchro top. In an embodiment, this synchro top may be a device integrated in the beacon. Thus, each beacon transmits its synchro top which is received by the others. As a reminder, these synchro tops serve to find a correlation point in the history of the messages received by the beacons and thus serve to prove a common temporal point which is next exploited for the trilateration calculations.

1. Method for generating a digital proof relative to the transmission of a message by a UWB radio tag comprising:
transmitting a first message by a UWB radio tag;
receiving said transmitted first message by at least two reception beacons;
generating at least one enriched message each comprising a temporal datum calculated from an arrival date of the first message and at least one signature by each of the beacons;
receiving the enriched messages by a calculator to generate a digital proof from the temporal data and signatures of each enriched message received.

2. The method according to claim 1, wherein at least one beacon is not connected to another beacon of the set of beacons having received the first message transmitted by the UWB radio tag.

3. The method according to claim 1, wherein each beacon comprises a memory in which is stored a digital key making it possible to generate a signature, at least two beacons comprising different keys.

4. The method according to claim 1, wherein each beacon generates a signature different from the other beacons.

5. The method according to claim 1, further comprising a step of reception of the enriched messages by a calculator to determine a position of said UWB radio tag from the temporal data of each enriched message generated by each beacon.

6. The method according to claim 1, wherein the signature data and the temporal data of each enriched message are stored in a data container forming a block of a blockchain, each block of said blockchain comprising a specific digital fingerprint.

7. The method according to claim 6, wherein the set of enriched messages generated by a beacon over a predefined time period are stored in a same blockchain.

8. The method according to claim 6, wherein the set of enriched messages generated by the set of beacons covering a same geographic zone over a predefined time period are stored in a same blockchain.

9. The method according to claim 1, wherein the digital proof comprises:
at least one pair of digital values, each digital value comprising at least one digital signature or;
a result of an operation aiming to correlate the values of the different signatures.

10. The method according to claim 1, wherein a calculator carries out an operation aiming to verify the conformity of the digital proof, said operation associating the different temporal data and the signatures of each beacon for each message transmitted by a radio tag.

11. The method according to claim 1, wherein a calculator of each beacon generates a log to at least one data server for storing the different temporal data and the signatures associated with the set of messages received from each beacon, said stored data being made accessible to a third party after an access control of said third party with a rights management service.

12. The method according to claim 1, wherein a device for transmitting a clock disseminates a synchronization datum to the different beacons.

13. The method according to claim 1, further comprising a step of generation of a composite signature from the set of signatures generated by each beacon during the reception of a same message transmitted by the UWB radio tag.

14. The method according to claim 1, wherein the UWB radio tag is associated with an electronic equipment comprising at least one sensor, said sensor measuring a datum of a physical parameter, said datum being inserted into the first message transmitted by the UWB radio tag, said datum being associated with the signature of each beacon for the calculation of a proof.

15. The method according to claim 1, wherein each beacon is configured to receive a datum from an electronic equipment comprising at least one sensor, said sensor measuring a datum, said datum being inserted into a new message transmitted by the electronic equipment, said datum being associated with the signature of each beacon for the calculation of a proof.

16. The method according to claim 1, wherein each beacon receives a same data stream transmitted by a data source, the method comprising a step of extraction by each beacon of a data portion from said data stream, said extracted data portion being integrated in an enriched message consecutively to the reception of a message by at least one beacon coming from the tag.

17. System comprising a set of beacons comprising a receiver for receiving messages transmitted by a UWB radio tag each beacon comprising a demodulator to extract the data received from said message, a calculator to:
extract at least one identification datum from said radio tag;
calculate a temporal information time stamping the reception of a message transmitted by the tag, said temporal marker being generated from a clock and a synchronization message, each beacon comprising an interface for receiving said synchronization signal and a memory for storing at least one digital key of said beacon;
generate a digital signature of a data set, said data being signed from at least said identification datum, the temporal information and a digital key stored in a memory of said beacon,
each of said beacons further comprising a transmitter for transmitting an enriched message comprising at least the identification of the tag, a temporal information generated by each beacon and a digital signature generated by each beacon, said system further comprising a data server configured to generate a proof from the different enriched messages received.
